(19) United States
(12) Patent Application Publication
(10) Pub. No.: US 2014/0139648 A1
(43) Pub. Date: May 22, 2014

(54) 3D DISPLAY APPARATUS, METHOD, COMPUTER-READABLE MEDIUM AND IMAGE PROCESSING DEVICE

(71) Applicant: KABUSHIKI KAISHA TOSHIBA, Tokyo (JP)

(72) Inventors: Nao MISHIMA, Tokyo (JP); Norihiro NAKAMURA, Kanagawa (JP); Takeshi MITA, Kanagawa (JP)

(73) Assignee: KABUSHIKI KAISHA TOSHIBA, Tokyo (JP)

(21) Appl. No.: 14/081,189

(22) Filed: Nov. 15, 2013

(30) Foreign Application Priority Data
Nov. 19, 2012 (JP) 2012-253241

(51) Int. Cl. H04N 13/04

(52) U.S. Cl. CPC H04N 13/04
USPC 348/51

(57) ABSTRACT

A 3D display apparatus according to an embodiment comprises a display unit, an input unit, an estimator, a generator and an output unit. The display unit is capable of displaying a plurality of parallax images as a 3D image. Each of the parallax images may have a mutually different parallax. An input unit may input an input image. An estimator may estimate a relative tilt angle of an interocular direction of an observer with respect to a reference direction having been preset on the display unit. A generator may generate the parallax images from the input image using the relative tilt angle, each of the parallax images having the mutually different parallax along the interocular direction. An output unit may make the display unit display the parallax images.

### CROSS-REFERENCE TO RELATED APPLICATION(S)

This application is based upon and claims the benefit of priority from the Japanese Patent Application No. 2012-253241, filed on Nov. 19, 2012; the entire contents of which are incorporated herein by reference.

### FIELD

An embodiment described herein relates generally to a 3D display apparatus, a method, a computer-readable medium and an image processing device.

BACKGROUND

In recent years, a 3D display enabling stereoscopic view without requiring the viewer to wear glasses by having a structure in that beam control elements in which linear optical apertures such as cylindrical lenses or barriers (slits), for instance, are periodically arrayed in a horizontal direction are arranged in front of a display element such as a liquid crystal panel, or the like, has been developed.

Furthermore, there is a 3D display enabling stereoscopic view by having a structure in that a microlens array in which fine lenses are 2D-arrayed is arranged in front of a display element. As one of such 3D image displays, there is a display which is able to change a view direction between a longitudinal direction and a lateral direction based on a horizontal angle of a liquid crystal panel while maintaining a stereoscopic view.

### BRIEF DESCRIPTION OF THE DRAWINGS

FIG. 1 is an outline view of a 3D display apparatus according to an embodiment;

FIG. 2 is a block diagram showing an outline structure of an image processor according to the embodiment;

FIG. 3 is a flowchart showing an operation example of the image processor according to the embodiment;

FIG. 4 is a flowchart showing an example of a relative angle estimating process according to the embodiment;

FIG. 5 is a flowchart showing an example of a parallax image generating process according to the embodiment;

FIG. 6 is a flowchart showing an example of a sub-pixel processing according to the embodiment;

FIG. 7 is a flowchart showing an example of a 3D-pixel coordinate calculating process according to the embodiment;

FIG. 8 is a flowchart showing an example of a view number calculating process according to the embodiment;

FIG. 9 is a flowchart showing an example of a pixel value calculating process according to the embodiment;

FIG. 10 is an illustration for explaining an example of the relative angle estimating process according to the embodiment;

FIG. 11 is an illustration for explaining an example of the view number calculating process according to the embodiment;

FIG. 12 is an illustration for explaining calculation of a view number for a target pixel in the view number calculating process according to the embodiment;

FIG. 13 is an illustration showing a pixel feature in a k1 coordinate system in the 3D-pixel coordinate calculating process according to the embodiment;

FIG. 14 is an illustration showing a pixel feature in an xy coordinate system in the 3D-pixel coordinate calculating process according to the embodiment;

FIG. 15 is an illustration for explaining calculation of a 3D-pixel coordinate in the xy coordinate system in the 3D-pixel coordinate calculating process according to the embodiment;

FIG. 16 is an illustration showing a relationship between a converted xy coordinate system and beam control elements in the 3D-pixel coordinate calculating process according to the embodiment;

FIG. 17 is an illustration showing a relationship between an angle-corrected xy coordinate system and the beam control elements in the 3D-pixel coordinate calculating process according to the embodiment; and

FIG. 18 is an illustration showing a relationship between a coordinate system after being reversed from the xy coordinate system to the k1 coordinate system and the beam control elements in the 3D-pixel coordinate calculating process according to the embodiment.

### DETAILED DESCRIPTION

Exemplary embodiments of a 3D display apparatus, a method, a computer-readable medium and an image processing device will be explained below in detail with reference to the accompanying drawings. A 3D display apparatus explained as an example below can provide a 3D image to an observer by displaying parallax images each of which has a mutually different parallax. The 3D display apparatus can adopt a 3D display system such as an integral imaging system (II system), a multi-view system, or the like. As examples of the 3D display apparatus, there are a TV, a PC, a smart phone, a digital photo frame on which observer can view a 3D image with a naked eye.

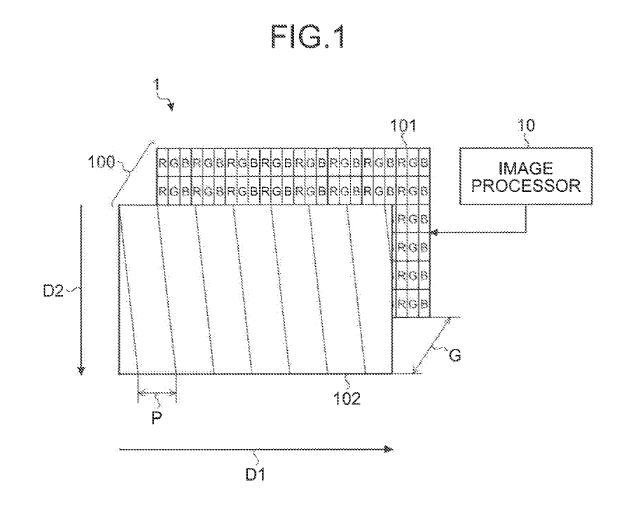

FIG. 1 is an outline view of a 3D display apparatus according to an embodiment. The 3D display apparatus 1 has a display unit 100 and an image processor 10.

The display unit 100 is a device capable of displaying a 3D image including parallax images each of which has a mutually different parallax. As shown in FIG. 1, the display unit 100 includes a display element (liquid crystal panel, for instance) 101 and a beam control member 102.

Multiview images are images used for providing a 3D image to an observer, and are individual images constructing the 3D image. The 3D image is an image in which pixels in the parallax images are assigned so that when an observer observes the display element 101 via the beam control member 102 from his/her view point, one eye of the observer observes one parallax image and the other eye of the observer observes another parallax image. That is, the 3D image is generated by permutating pixels of each parallax image.

To the display element 101 for displaying the 3D image, the parallax images are inputted from the image processor 10. The display element 101 has a structure in that a plurality of pixels are 2D-arrayed. More specifically, in the display element 101, a plurality of sub-pixels with difference colors (R, G, B, for instance) are arrayed in a matrix in a first direction (row direction) D1 and a second direction (column direction) D2. In an example shown in FIG. 1, one pixel is constructed from sub-pixels of the three colors of RGB. The sub-pixels are periodically arrayed in the first direction D1 in an order of R (red), G (green) and B (blue), and the same color sub-pixels are arrayed in the second direction D2. As the display element 101, a direct-view-type display such as an organic EL (electro luminescence), a LCD (liquid crystal display), a PDP (plasma display panel), a projection display, or the like, for instance, is used. The display element 101 may have a backlight. In the following, the display element 101 may be referred to as a liquid crystal panel or simply a panel.

The beam control member 102 controls an emitting direction of a beam emitted from each sub-pixel of the display element 101. In the beam control member 102, a plurality of optical apertures for emitting beams are extended linearly. The plurality of the optical apertures are arrayed in the first direction D1 with a period of a pitch P. In the example of FIG. 1, the beam control member 102 may be a lenticular seat in which a plurality of cylindrical lenses, each of which functions as an optical aperture, are arrayed in the first direction D1 with the period of the pitch P. However, the structure is not limited to such example while the beam control member 102 may be a parallax barrier in which a plurality of slits are arrayed in the first direction D1 with the period of the pitch P, for instance. The display element 101 and the beam control member 102 have a certain gap G in between. Furthermore, the beam control member 102 may be arranged so that a drawing direction of the optical apertures is inclined to have a certain angle with respect to the second direction (column direction) D2 of the display element 101. In such structure, due to relative positions of the optical apertures and displaying pixels in the first direction (row direction) D1 being varied depending on height positions in the second direction (column direction) D2, view ranges (available angular ranges for observing a 3D image) are changed depending on the height positions.

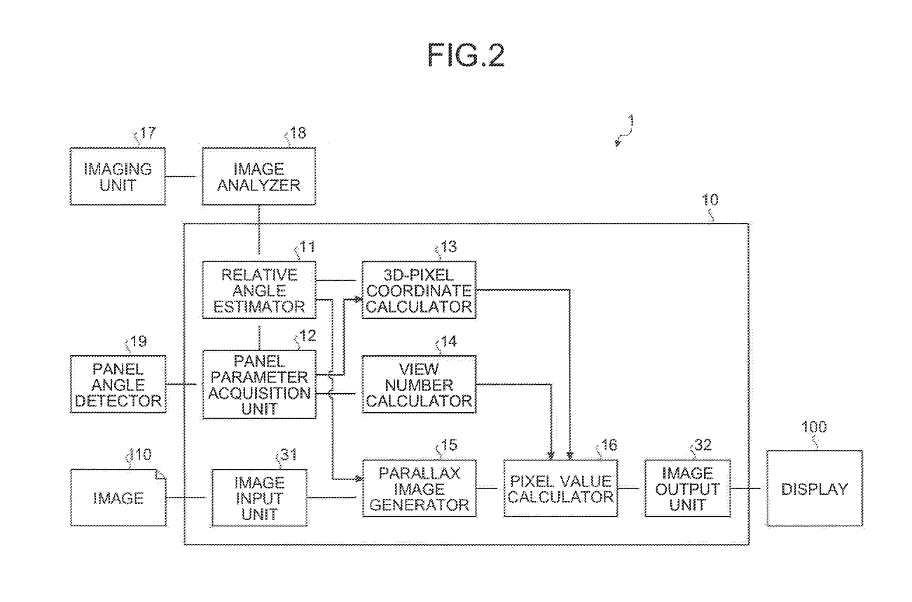

FIG. 2 is a block diagram showing an outline structure of an image processor according to the embodiment. The image processor 10 has an image input unit 31, a relative angle estimator 11, a panel parameter acquisition unit 12, a 3D-pixel coordinate calculator 13, a view number calculator 14, a parallax image generator 15, a pixel value calculator 16 and an image output unit 32. To the image processor 10, an image analyzer 18, a panel angle detector 19 and a display unit 100 are connected. The image input unit 31 receives an image I10 outputted from an external superior device and provides/sends the image I10 to the parallax image generator 15. The image I10 may be a stationary picture or a single frame of a motion picture.

The image processor 10 shown in FIG. 2 may be provided by having a processing unit such as a CPU (central processing unit) reading out a program stored in a memory such as a ROM (read only memory) or a RAM (random access memory) and executing the program. Or the image processor 10 may be provided as a dedicated chip.

The image analyzer 18 specifies a direction (interocular direction) of a line (eye line) connecting both eyes of the observer by obtaining an image what is ahead of the display unit 100 taken by the imaging unit 17 and analyzing the image. The imaging unit 17 imaging what is ahead of the display unit 100 may be a CCD (charge-coupled device) camera. The imaging unit 17 can be built in the 3D display apparatus 1 or can be external.

The panel angle detector 19 may be constructed from an accelerator (or gravity sensor), a gyro sensor, or the like, for instance, and detects a tilt angle of a predetermined direction of the liquid crystal panel 101 (the first direction D1, for instance) with respect to a horizontal direction (or a vertical direction). In the following, the first direction D1 may be referred to as a panel direction D1.

The panel parameter acquisition unit 12 acquires and stores a parameter about a correspondence relation between the liquid crystal panel 101 and the beam control member 102 as a panel parameter. The panel parameter may include the tilt angle of the panel direction D1 of the liquid crystal panel 101 with respect to the horizontal direction, the pitch P of the optical apertures in the beam control member 102 (a width of a cylindrical lens, for instance), a difference (offset) between a reference position of the liquid crystal panel 101 and a reference position of the beam control member 102, and so forth.

The relative angle estimator 11 estimates a relative tilt angle of the interocular direction with respect to the panel direction D1 of the liquid crystal panel 101 based on information about the interocular direction inputted from the image analyzer 18 and the panel parameter inputted from the panel parameter acquisition unit 12. The relative tilt angle may be estimated as an elevation angle with respect to the panel direction D1 of the liquid crystal panel 101.

The 3D -pixel coordinate calculator 13 calculates a 3D -pixel coordinate in a coordinate system in which interocular direction is defined as a reference direction (e.g., x axis) using information about the relative tilt angle inputted from the relative angle estimator 11 and the panel parameter inputted from the panel parameter acquisition unit 12. The 3D -pixel coordinate is in a coordinate system used for displaying parallax images, and a unit of the 3D -pixel coordinate is a single pixel. In the following, in order to distinguish a coordinate system preset to the liquid crystal panel 101 and a coordinate system of the 3D -pixel coordinate, the coordinate system of the liquid crystal panel 101 is defined as a k1 coordinate system, and the coordinate system of the 3D -pixel coordinate is defined as an xy coordinate system. Furthermore, the k1 coordinate system may also be referred to as a panel coordinate. Accordingly, the 3D -pixel coordinate calculator 13 converts the panel coordinate into the 3D -pixel coordinate by space-converting the k1 coordinate system of the liquid crystal panel 101 into the xy coordinate system. Here, in the k1 coordinate system, k axis corresponds to the first direction (panel direction) D1 in FIG. 1, and 1 axis corresponds to the second direction in FIG. 1, for instance. Furthermore, in the xy coordinate system, x axis corresponds to the interocular direction, and y axis corresponds to a direction perpendicular to the eye line. The xy coordinate system lies at the same plane as the k1 coordinate system.

The view number calculator 14 calculates the view numbers (also referred to as parallax numbers) corresponding to camera positions at a time of taking the image I10 using the panel parameter inputted from the panel parameter acquisition unit 12.

The parallax image generator 15 generates one or more parallax images each of which has a mutually different parallax on a line of the interocular direction based on the image I10 inputted from the exterior and on the information about the relative tilt angle inputted from the relative angle estimator 11. The parallaxes on the line of the interocular direction may be preset.

The pixel value calculator 16 calculates a pixel value of each pixel of the liquid crystal panel 101 using the inputted 3D pixel coordinates, the view numbers and the parallax images. The calculated pixel values are inputted into an active matrix drive circuit (not shown) of the display unit 100 via the image output unit 32 as image data being target for stereoscopic display. Thereby, the image I10 is stereoscopically displayed on the display unit 100.

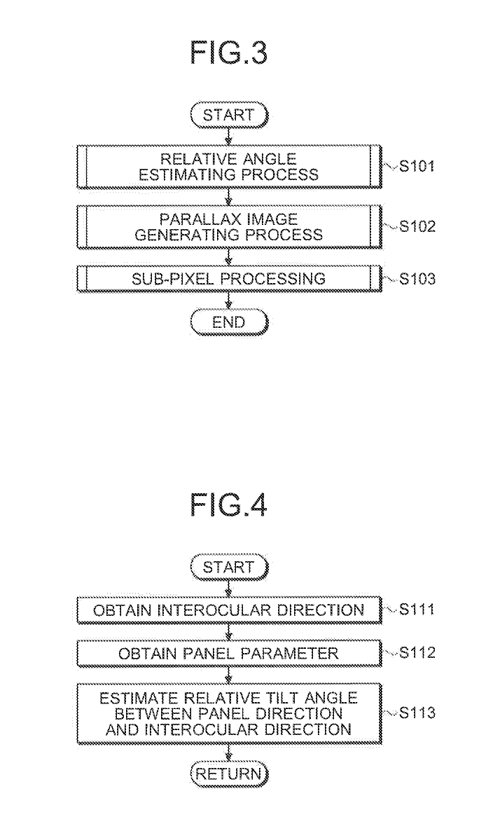

Next, an operation example of the image processor 10 shown in FIG. 2 will be described in detail with reference to the accompanying drawings. FIG. 3 is a flowchart showing an operation example of the image processor shown in FIG. 2. As shown in FIG. 3, the image processor 10, when the image I10 is inputted via the image input unit 31, executes a relative angle estimating process at the relative angle estimator 11 for estimating the relative tilt angle of the interocular direction with respect to the panel direction of the liquid crystal panel 101 (step S101). Then the image processor 10, at the parallax image generator 15, executes a parallax image generating process for generating parallax images each of which has a mutually different parallax on the line of the interocular direction based on the input image I10 (step S102). Then the image processor 10 executes a sub-pixel processing for calculating the pixel values used for driving the sub-pixels of the display unit 100 by operating the 3D -pixel coordinate calculator 13, the view number calculator 14 and the pixel value calculator 16 (step S103). Thereby, an array data of the pixel values for stereoscopically displaying the image I10 on the display unit 100 can be generated.

FIG. 4 is a flowchart showing an example of the relative angle estimating process shown in step S101 in FIG. 3. As shown in FIG. 4, in the relative angle estimating process, the relative angle estimator 11 obtains the interocular direction of a person included in an image taken by the imaging unit 17 from the image analyzer 18 (step S111), and obtains the panel parameter of the liquid crystal panel 101 from the panel parameter acquisition unit 12 (step S112). The panel parameter obtained in step S112 includes at least the information about the panel direction of the liquid crystal panel 101.

Next, the relative angle estimator 11 estimates the relative tilt angle between the obtained interocular direction and the obtained panel direction (step S113), and then returns to the operation shown in FIG. 3. The information about the estimated relative tilt angle is inputted to the 3D -pixel coordinate calculator 13 and the parallax image generator 15, respectively. Here, when the interocular direction is defined as a direction connecting from a right eye to a left eye, for instance, the relative tilt angle may be estimated as an angle within a range of 0 degrees to 360 degrees. On the other hand, when the interocular direction is simply defined as a line connecting both eyes, for instance, the relative tilt angle may be estimated as an elevation angle of the interocular direction with respect to the panel direction, for instance. In this case, the elevation angle of the interocular direction with respect to the panel direction should be estimated within a range of −90 degrees to 90 degrees.

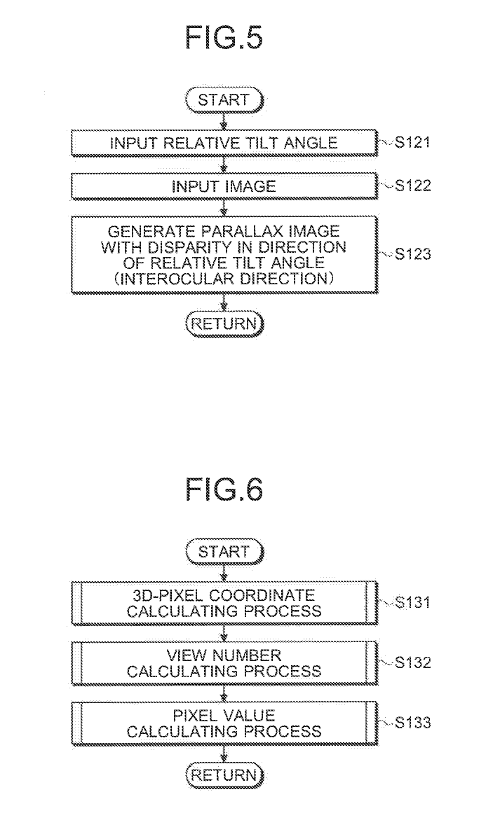

FIG. 5 is a flowchart showing an example of the parallax image generating process shown in step S102 in FIG. 3. As shown in FIG. 5, in the parallax image generating process, the parallax image generator 15 receives the information about the relative tilt angle estimated in step S101 in FIG. 3 from the relative angle estimator 11 (step S121), and receives data of the image I10 for stereoscopically display from the external superior device (step S122). Then the parallax image generator 15 generates one or more parallax images each of which has a mutually different parallax on the line of the interocular direction based on the inputted relative tilt angle (step S123), and then returns to the operation shown in FIG. 3. One or more parallax images may be generated by setting one or more view points on the line of the interocular direction and rendering to a predetermined plane using each view point as a base point. The generated parallax images are inputted to the pixel value calculator 16. The parallax images to be inputted to the pixel value calculator 16 can include the original image I10.

FIG. 6 is a flowchart showing an example of the sub-pixel processing shown in step S103 in FIG. 3. As shown in FIG. 6, in the sub-pixel processing, a 3D -pixel coordinate calculating process for calculating 3D -pixel coordinates (step S131), a view number calculating process for calculating a view number for each pixel in each parallax image (step S132), and a pixel value calculating process for calculating a pixel value for each pixel (step S133) are sequentially executed in this order.

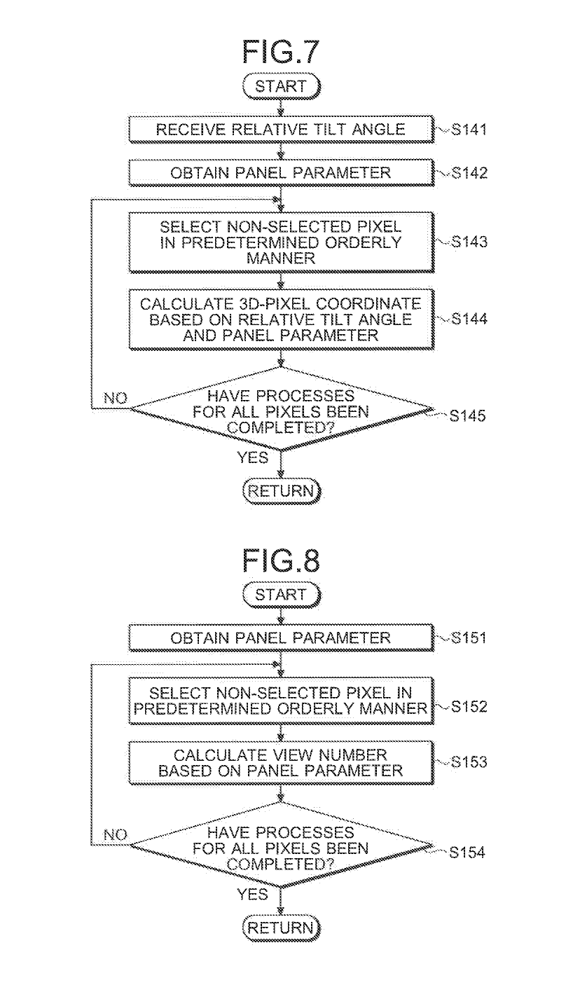

FIG. 7 is a flowchart showing an example of the 3D -pixel coordinate calculating process shown in step S131 in FIG. 6. As shown in FIG. 7, in the 3D -pixel coordinate calculating process, the 3D -pixel coordinate calculator 13 receives the relative tilt angle estimated in step S101 of FIG. 3 from the relative angle estimator 11 (step S141), and obtains the panel parameter of the liquid crystal panel 101 from the panel parameter acquisition unit 12 (step S142). Then the 3D -pixel coordinate calculator 13 selects one non-selected pixel in the k1 coordinate system of the liquid crystal panel 101 in accordance with a predetermined order (step S143). Then the 3D -pixel coordinate calculator 13 calculates the 3D -pixel coordinates by converting a coordinate system of a panel coordinate of the selected pixel from the k1 coordinate system to the xy coordinate system based on the inputted relative tilt angle and the obtained panel parameter (step S144). Then the 3D -pixel coordinate calculator 13 determines whether processes for all the pixels in the k1 coordinate system are completed or not (step S145), and when the processes for all the pixels are completed (step S145; YES), returns to the operation shown in FIG. 6. On the other hand, when an unprocessed pixel is remaining (step S145; NO), the 3D -pixel coordinate calculator 13 returns to step S143 and executes the following processes.

FIG. 8 is a flowchart showing an example of a view number calculating process shown in step S132 in FIG. 6. As shown in FIG. 8, in the view number calculating process, the view number calculator 14 obtains the panel parameter of the liquid crystal panel 101 from the panel parameter acquisition unit 12 (step S151). Then the view number calculator 14 selects one non-selected pixel among the pixels of the liquid crystal panel 101 in accordance with a predetermined order (step S152), and calculates the view number for the selected pixel based on the obtained panel parameter (step S153). And then the view number calculator 14 determines whether processes for all the pixels are completed or not (step S154), and when the processes are completed (step S154; YES), returns to the operation shown in FIG. 6. On the other hand, when an unprocessed pixel remains (step S154; NO), the view number calculator 14 returns to step S152 and executes the following processes. Here, the selection order of pixels may be an order such that selection starts from an upper left corner progressing rightward for every row from an upper row down to a lower row.

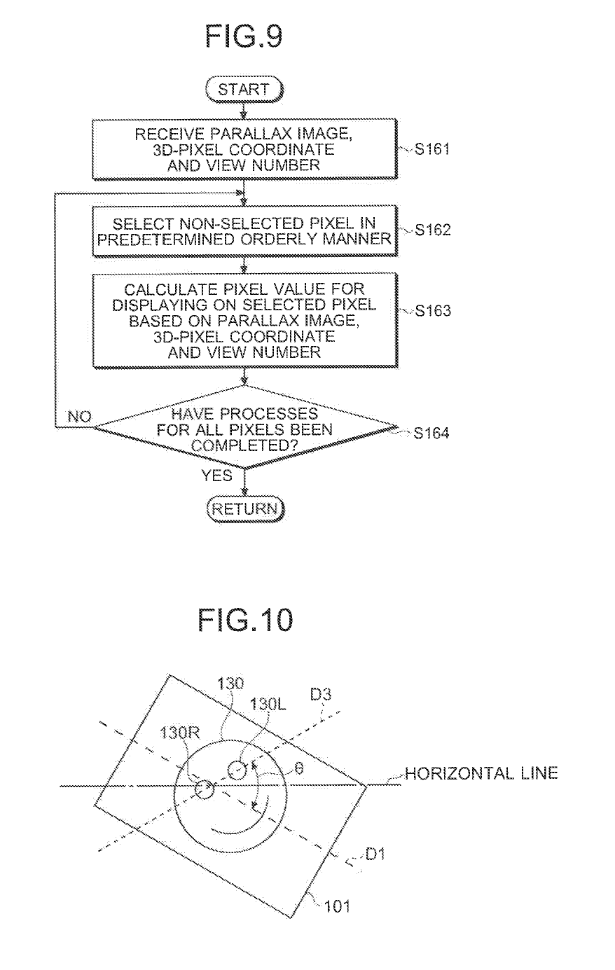

FIG. 9 is a flowchart showing an example of a pixel value calculating process shown in step S133 in FIG. 6. As shown in FIG. 9, in the pixel value calculating process, the pixel value calculator 16 receives the parallax images from the parallax image generator 15, the 3D -pixel coordinate from the 3D -pixel coordinate calculator 13, and the view numbers from the view number calculator 14, respectively (step S161). Then the pixel value calculator 16 selects one non-selected pixel among the pixels of the liquid crystal panel 101 in accordance with a predetermined order (step S162), and calculates the pixel values to be displayed on the selected pixel based on the inputted parallax images, the inputted 3D -pixel coordinates and the inputted view numbers (step S163). The selection order may be the same as the selection order of step S152 in FIG. 8. And then the pixel value calculator 16 determines whether processes for all the pixels are completed or not (step S164), and when the processes are completed (step S164; YES), returns to the operation shown in FIG. 6. On the other hand, when an unprocessed pixel remains (step S164; NO), the pixel value calculator 16 returns to step S162 and executes the following processes. According to the above-described operation, the array data of the pixel values for driving each pixel of the liquid crystal panel 101 is calculated. The calculated pixel values are inputted to the display unit 100 via the image output unit 32 as image data for stereoscopical displaying.

Next, details of each process described above will be explained using specific examples. FIG. 10 is an illustration for explaining an example of the relative angle estimating process. As shown in FIG. 10, to the relative angle estimator 11, an interocular direction D3 is inputted from the image analyzer 18. The interocular direction D3 may be a line connecting a right eye 130R and a left eye 130L of a person's face analyzed at the image analyzer 18. The relative angle estimator 11 obtains at least information about the panel direction D1 of the liquid crystal panel 101 from among the panel parameters from the panel parameter acquisition unit 12. The relative angle estimator 11, based on the interocular direction D3 and the panel direction D1, estimates an amount of rotation of the interocular direction D3 from the panel direction D1 as being a reference.

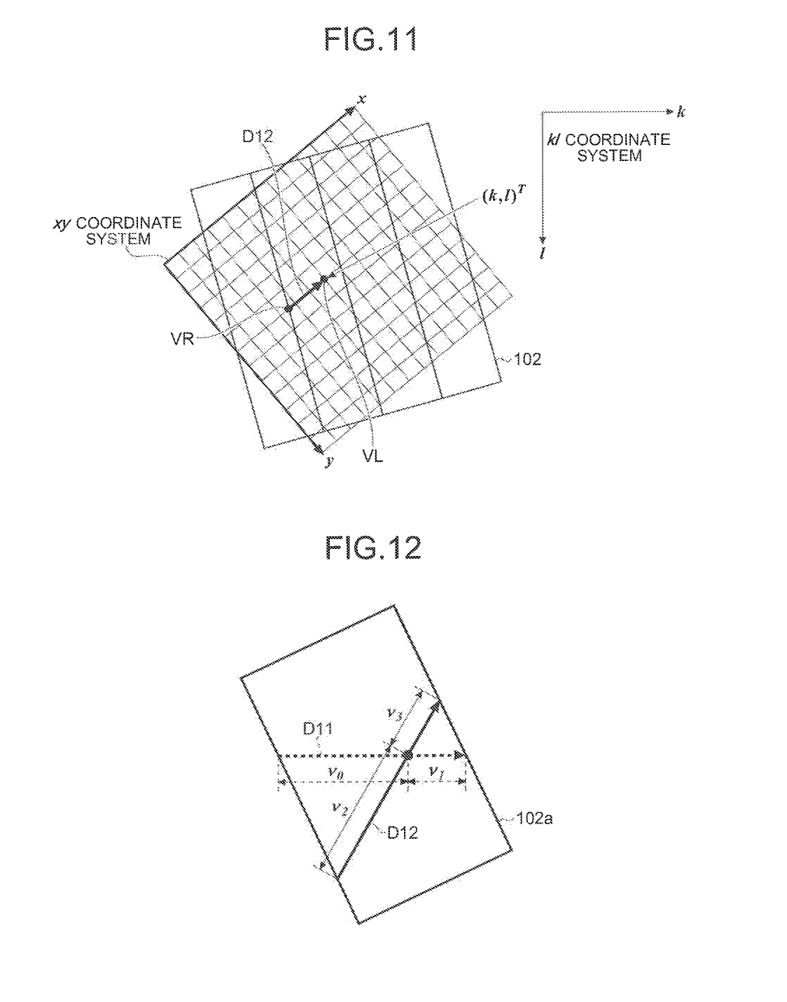

FIGS. 11 and 12 are illustrations for explaining an example of the view number calculating process. FIG. 11 is an illustration showing an xy coordinate system obtained by rotating a k axis of the k1 coordinate system so that the k axis faces the same direction as the interocular direction. FIG. 12 is an illustration for explaining a calculation of a view number for a target pixel.

As shown in FIG. 11, when a parallax is arranged on a line of the interocular direction D3, for calculating a view number for each pixel, the coordinate system thereof is converted from a k1 coordinate system to an xy coordinate system. In converting the k1 coordinate system to the xy coordinate system, for instance, the k1 coordinate system is rotated around the target pixel (pixel (k, 1)^{T}, for instance) such that the k axis of the k1 coordinate system faces the same direction as the interocular direction D3. As a result, to the target pixel (k, 1)^{T}, a parallax D12 is arranged. A starting point VR of the parallax D12 corresponds to a right-end view point, for instance, and an end point VL of the parallax D12 corresponds to a left-end view point, for instance.

Here, as shown in FIG. 12, from a scaling relationship of triangle, a view number in the k1 coordinate system is the same as a view number in the xy coordinate system. That is, when a distance from a left edge (starting side of the parallax) of one beam control member 102a to the target pixel (k, 1)^{T} on a line along a parallax direction (direction of k axis) in the k1 coordinate system is defined as V₀, a distance from the target pixel (k, 1)^{T} to a right edge (extension side of the parallax direction) of the beam control member 102a on the same line (direction of k axis) is defined as V₁, a distance from a left edge of the beam control member 102a to the target pixel (k, 1)^{T} on a line along a parallax direction (direction of x axis) in the xy coordinate system is defined as V₂, and a distance from the target pixel (k, 1)^{T} to a right edge of the beam control member 102a on the same line (direction of x axis) is defined as V₃, the following formula (1) is established.

v₂+v₃=N

v₀+v₁=N (1)

Because the view number can be calculated by an internal ratio along the parallax direction from the beam control member 102a, based on the scaling relationship of triangle, the following formula (2) can be established.

v₀:v₁=v₂:v₃

v₀v₃=v₁v₂

v₀(N−v₂)=v₂(N−v₀)

v₀N−v₀v₂=v₂N−v₀v₂

v₀=v₂ (2)

From the formula (2), it can be understood that even if the xy coordinate system is inclined with respect to the k1 coordinate system, the view number is constant.

Furthermore, in the view number calculating process, the view numbers can be calculated based on the relative tilt angle φ so that the view range of the parallax images displayed on the display unit 100 becomes constant. Thereby, it is possible to prevent troubles such as a part of the image (especially, a periphery part of the display) not being able to be sterically-displayed from occurring. Such trouble can also be prevented by presetting the view range and canceling the view numbers sticking out from the view range.

Moreover, when each beam control member 102a has a function of changing a focal length by changing a shape thereof based on an impressed voltage, the display unit 100 can include a lens controller for changing a shape of each beam control member 102a by adjusting a voltage to be impressed to each beam control member 102a based on the relative tilt angle φ. According to such structure, because canceling the stray view number in order to make the view range constant is no longer necessary, it is possible to display the 3D image in a wider view range.

However, if the beam control member 102 has a structure in that a plurality of cylindrical lenses are arrayed in the same direction (lens direction), when the relative tilt angle between the panel direction D1 and the interocular direction D3 becomes over a certain angle, for instance, there is a case in that the display unit 100 may not be able to display an image stereoscopically. Therefore, in this embodiment, when the relative tilt angle becomes over a certain angle, it is possible to arrange such that the lens direction is switched from a longitudinal direction to a lateral direction. According to such structure, even if the relative tilt angle becomes over the certain angle, it is possible to stereoscopically display the image on the display unit 100. As for the structure for switching the lens direction from a longitudinal direction to a lateral direction, it is possible to adopt a lens of which optical direction is changed based on a direction of an impressed voltage as the beam control member 102a.

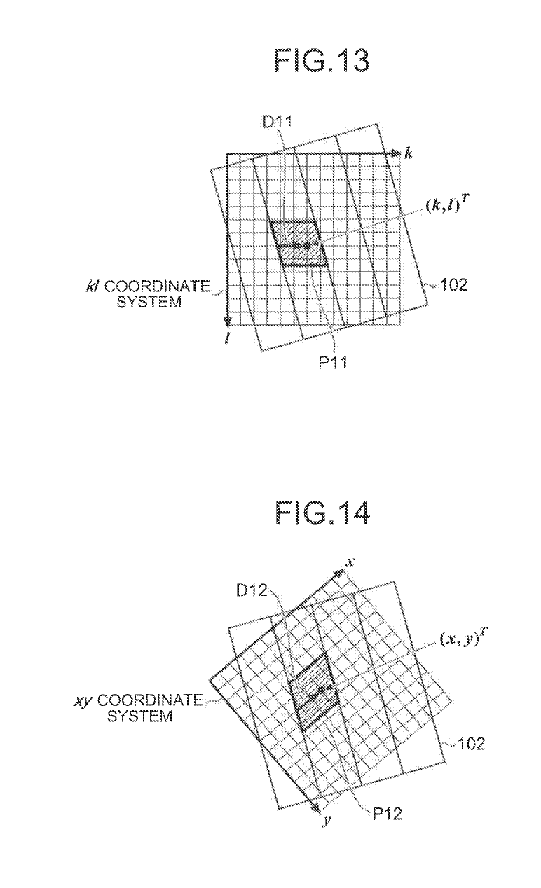

FIGS. 13 to 18 are illustrations for explaining an example of the 3D -pixel coordinate calculating process. FIG. 13 is an illustration showing a pixel shape in the k1 coordinate system, and FIG. 14 is an illustration showing a pixel shape in the xy coordinate system. As evidenced by comparing FIG. 13 and FIG. 14, a pixel shape of a pixel P11 (see FIG. 13) in the k1 coordinate system with a parallax D11 on the panel direction D1 of the liquid crystal panel 101 differs from a pixel shape of a pixel P12 (see FIG. 14) in the xy coordinate system with a parallax D12 on the interocular direction D3. A point (k, 1)^{T} in FIG. 13 corresponds to a point (x, y)^{T} in FIG. 14.

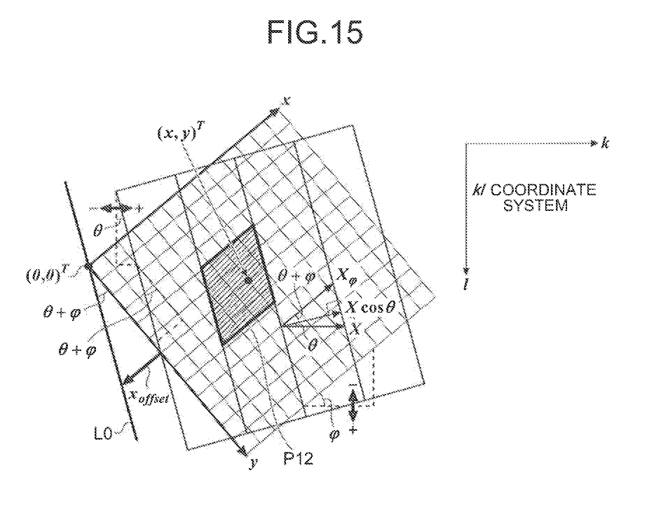

Here, as shown in FIG. 15, when a tilt angle (hereinafter referred to as a lens tilt angle) of a longer direction of each beam control member 102a with respect to a direction (direction of 1 axis) perpendicular to the panel direction D1 of the display unit 100 is defined as θ, and a relative tilt angle between the panel direction D1 and the interocular direction D3 (i.e., a tilt angle of the x axis in the xy coordinate system with respect to the k axis in the k1 coordinate system) is defined as φ, a tilt angle of the interocular direction D3 (x axis) with respect to the longer direction of each beam control member 102a becomes θ+φ. In FIG. 15, the condition of θ is that an anticlockwise direction is a positive direction and a clockwise direction is a negative direction, while the condition of φ is that a clockwise direction is a positive direction and an anticlockwise direction is a negative direction.

In the 3D -pixel coordinate calculating process, the coordinate system of the pixel is converted from the k1 coordinate system to the xy coordinate system. For such conversion, a coordinate converting rotation matrix as shown in the following formula (3) is used.

$$R ( φ ) = [ \begin{matrix}cos φ & sin φ \\ - sin φ & cos φ\end{matrix} ] \qquad ( 3 )$$

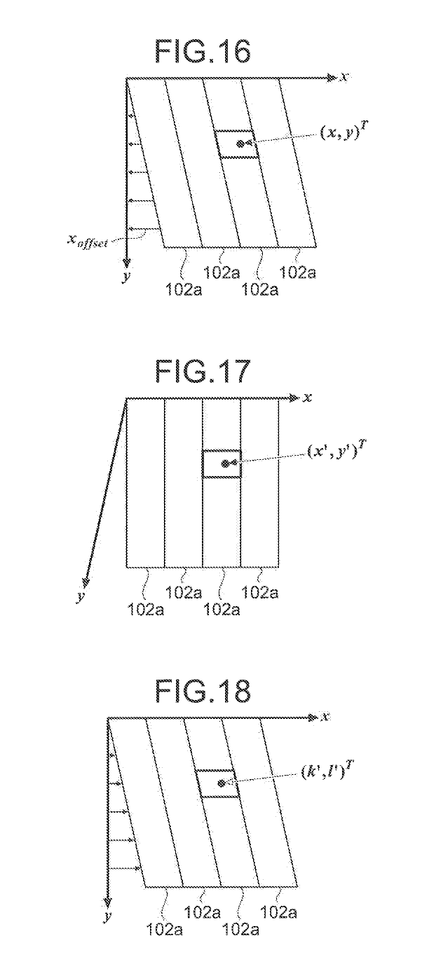

Here, it is assumed that the panel parameter acquisition unit 12 inputs a lens tilt angle=θ, a lens pitch=X, an offset=k_{offset} to the 3D -pixel coordinate calculator 13 as the panel parameters. Furthermore, a panel coordinate of a target pixel is defined as (k, 1)^{T}, and an aspect thereof is defined as (aₓ, a_{y})^{T}. In such case, a converted coordinate (x, y)^{T} of the target pixel in the xy coordinate system can be obtained as shown in FIG. 16 from the following formula (4). In addition, the lens pitch is a pitch between each adjacent beam control members 102a and corresponds to a width of each beam control member 102a. The offset is a distance between the 1 axis in the k1 coordinate system and a left edge of each of the beam control members 102a in the direction of the k axis. The offset varies based on a value of the 1 coordinate.

$$[ \begin{matrix}x \\ y\end{matrix} ] = R ( ϕ ) [ \begin{matrix}{a}_{x} ( k + {k}_{offset} ) \\ {a}_{y} l\end{matrix} ] \qquad ( 4 )$$

Next, a tilt (lens tilt angle θ) of each beam control member 102a with respect to the xy coordinate system will be corrected. As shown in FIG. 16, a distance (offset) between the y axis in the xy coordinate system and a left edge of each of the beam control members 102a in the direction of the x axis can be obtained using the following formula (5).

_{offset}=y tan(θ+φ) (5)

Accordingly, an angle-corrected coordinate (x′, y′)^{T} as shown in FIG. 17 can be represented as the following formula (6).

$$[ \begin{matrix}{x}^{′} \\ {y}^{′}\end{matrix} ] = [ \begin{matrix}x - {x}_{offset} \\ y\end{matrix} ] \qquad ( 6 )$$

An angle-corrected pitch (lens pitch X_{φ}) of the beam control members 102a can be obtained by the following formula (7)

$${X}_{ϕ} = X \frac{cos θ}{cos ( θ + ϕ )} \qquad ( 7 )$$

Thereby, a 3D -pixel coordinate (i, j)^{T} of the target pixel can be obtained as the following formula (8).

$$[ \begin{matrix}i \\ j\end{matrix} ] = [ \begin{matrix}⌊ {x}^{′} / {X}_{ϕ} ⌋ \\ ⌊ {y}^{′} / Y ⌋\end{matrix} ] \qquad ( 8 )$$

Next, in the 3D -pixel coordinate calculating process, in order to conform to an actual driving of the liquid crystal panel 101, as shown in FIG. 18, a process for restoring the coordinate system of the obtained 3D -pixel coordinate (i, j)^{T} to the original k1 coordinate system is executed. In this process, firstly, the tilt angle of the beam control members 102a is restored using the following formula (9).

$$[ \begin{matrix}{x}^{″} \\ {y}^{″}\end{matrix} ] = [ \begin{matrix}{iX}_{ϕ} + {x}_{offset} \\ jY\end{matrix} ] \qquad ( 9 )$$

Next, by using the following formula (10), the coordinate system of the 3D -pixel coordinate is restored from the xy coordinate system to the k1 coordinate system. In this explanation, for clarification, a coordinate (k′, 1′)^{T} obtained by the following formula (10) is also referred to as a 3D -pixel coordinate.

$$[ \begin{matrix}{k}^{′} \\ {l}^{′}\end{matrix} ] = ( R ( - ϕ ) [ \begin{matrix}{x}^{″} \\ {y}^{″}\end{matrix} ] ) / [ \begin{matrix}{a}_{x} \\ {a}_{y}\end{matrix} ] \qquad ( 10 )$$

As described above, the 3D -pixel coordinate obtained in the above manner is inputted to the pixel value calculator 16. The pixel value calculator 16 calculates a pixel value of each pixel based on the inputted 3D -pixel coordinate, the inputted parallax images and the inputted view number. The display unit 100 displays the image I10 stereoscopically by being driven according to the calculated pixel values.

As described above, in the embodiment, the relative tilt angle φ between the panel direction D1 and the interocular direction D3 is obtained, the parallax images each of which has a mutually different parallax on the line of the interocular direction D3 are generated based on the relative tilt angle φ, and the parallax images are displayed on the display unit 100. Thereby, according to the embodiment, even if the relative tilt angle φ between the liquid crystal panel 101 and a face of a person is varied, it is possible to display the images stereoscopically with high quality according to the relative tilt angle φ.

In the embodiment, when the relative tilt angle φ is 0 degrees, 90 degrees, 180 degrees or 270 degrees, i.e. the panel direction D1 is perpendicular to the interocular direction D3, it is possible to have a simple structure in that the image I10 is rotated according to the relative tilt angle and parallax images each of which has a mutually different parallax on the line in the direction of the relative tilt angle (0 degrees, 90 degrees, 180 degrees or 270 degrees) are generated from the rotated image I10 without having the above-described sub-pixel process executed.

Furthermore, in the embodiment, although the case where the image I10 is not rotated according to the tilt angle of the panel direction D1 with respect to the horizontal direction or the relative tilt angle is explained as an example, this embodiment is not limited to such case. The image I10 can be rotated according to the tilt angle of the panel direction D1 with respect to the horizontal direction or the relative tilt angle. Thereby, it is possible to stereoscopically display the image I10 with a better visualization for the observer. Such structure can be achieved by having a process of rotating the image I10 according to the tilt angle of the panel direction D1 with respect to the horizontal direction or the relative tilt angle in addition to the structure of the above-described embodiment. The rest of the following processes on the rotated image I10 may be the same as the above-described processes in the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A 3D display apparatus comprising:
a display unit capable of displaying parallax images as a 3D image, each of the parallax image having a mutually different parallax;
an input unit configured to input an input image;
an estimator configured to estimate a relative tilt angle of an interocular direction of an observer with respect to a reference direction having been preset on the display unit;
a generator configured to generate the parallax images from the input image using the relative tilt angle, each of the parallax images having the mutually different parallax along the interocular direction; and
an output unit configured to make the display unit display the generated parallax images.

2. The apparatus according to claim 1, wherein
the generator generates the parallax images each of which has the mutual different parallax on a line of the interocular direction of which absolution value of the relative tilt angle with respect to the reference direction of the display unit is greater than 0 degrees and smaller than 90 degrees.

3. The apparatus according to claim 2, wherein
the display unit includes
a display element having a plurality of pixels, and
a plurality of beam control elements configured to control emitting directions of beams emitted from the pixels,
the apparatus further comprising:
a view number calculator configured to calculate view numbers using display parameters including angles of the plurality of the beam control elements with respect to the reference direction of the display unit and pitches of the plurality of the beam control elements;
a coordinate calculator configured to calculate 3D -pixel coordinates for displaying the parallax images as a 3D image based on the display parameters and the relative tilt angle; and
a pixel value calculator configured to calculate a pixel value of each pixel from the parallax image based on the view numbers and the 3D -pixel coordinates,
the display unit driving each pixel according to the calculated pixel value.

4. The apparatus according to claim 1, wherein
the generator rotates the image based on the relative tilt angle and generates the parallax images each of which has the mutually different parallax on a line of the interocular direction from the rotated image.

5. The apparatus according to claim 1, further comprising
a detector configured to detect the interocular direction.

6. The apparatus according to claim 1, further comprising:
a lens controller configured to change shapes of the plurality of the beam control elements by controlling voltages impressed to the plurality of the beam control elements based on the relative tilt angle.

7. A method for displaying an image stereoscopically on a display device having a display unit capable of displaying parallax images as a 3D image, each of the parallax images having a mutually different parallax, the method including:
obtaining an input image;
estimating a relative tilt angle of an interocular direction of an observer with respect to a reference direction having been preset on the display unit;
generating the parallax images from the input image using the relative tilt angle, each of the parallax images having the mutually different parallax along the interocular direction; and
displaying the parallax images on the display unit.

8. A non-transitory computer readable medium including a program for operating a computer in a display device having a display unit capable of displaying parallax images as a 3D image, each of the parallax images having a mutually different parallax, the program comprising the instructions of:
obtaining an input image;
estimating a relative tilt angle of an interocular direction of an observer with respect to a reference direction preset on the display unit;
generating the parallax images from the input image using the relative tilt angle, each of the parallax images having the mutually different parallax along the interocular direction; and
displaying the parallax images on the display unit.

9. An image processing device which can be connected with a display unit capable of displaying parallax images as a 3D image, each of the parallax images having a mutually different parallax, the device comprising:
an input unit configured to input an input image;
an estimator configured to estimate a relative tilt angle of an interocular direction of an observer with respect to a reference direction having been preset on the display unit;
a generator configured to generate the parallax images from the input image using the relative tilt angle, each of the parallax images having the mutually different parallax along the interocular direction; and
an output unit configured to make the display unit display the parallax images.
